(19) United States
(12) Patent Application Publication
(10) Pub. No.: US 2009/0219492 A1
(43) Pub. Date: Sep. 3, 2009

(54) DETECTING DEVICE

(75) Inventors: Yi-Chang Tsai, Hsin-Chu (TW); Juita Liu, Hsin-Chu (TW); Ming-Wen Chen, Hsin-Chu (TW); Tzu-Tse Huang, Hsin-Chu (TW)

Correspondence Address: KIRTON AND MCCONKIE, 60 EAST SOUTH TEMPLE,, SUITE 1800, SALT LAKE CITY, UT, 84111, US

(73) Assignee: CORETRONIC CORPORATION, Hsin-Chu (TW)

(21) Appl. No.: 12/112,132

(22) Filed: Apr. 30, 2008

(30) Foreign Application Priority Data
Feb. 29, 2008 (TW) 097107135

(51) Int. Cl. G03B 21/16

(52) U.S. Cl. 353/52

(57) ABSTRACT

A detection device is mounted in a projector for detecting relations between an object and the projector. The detection device includes a detecting switch, a connector and a detecting circuit. When the object is placed into the detecting switch, the detecting switch is in an off state. When the object is withdrawn from the detecting switch, the detecting switch is in an on state. The connector is electrically connected to the detecting switch. The detecting circuit is electrically connected to the connector for activating the projector to be operated in a first mode in response to the off state of the detecting switch and activating the projector to be operated in a second mode in response to the on state of the detecting switch. The first mode and the second mode are associated with the temperature inside the projector.

The present invention relates to a detecting device, and more particularly to a detecting device for detecting whether an object is mounted on a projector, thereby controlling internal operations of the projector.

### BACKGROUND OF THE INVENTION

With rapid development of fabricating techniques, projectors become essential electronic appliances in many applications. For example, projectors can be used for presentations in conferences, viewing movies in home theaters, and the like. For enhancing operating performance of projectors, many kinds of peripheral components have been developed. For example, a dust-proof cover is mounted on a projector in order to operate the projector in a relatively dust-proof environment. In addition, all projectors have specified heat-dissipating designs, e.g. airflow inlets/outlets and cooling fans, for dissipating heat generated from high temperature lamps of the projectors. During operation of the cooling fan, external air is inhaled into the interior of the projector through the airflow inlet to dissipate the heat of the lamp and the circuit board, and then the heated airflow is exhausted from the airflow outlet. In a case that a projector is used in an environment with much dust (e.g. a classroom), the dust is readily inhaled into the interior of projector along with the inhaled air. Under this circumstance, the interior of the projector is contaminated by the dust. In addition, accumulation of dust on the optical components and the circuit board may deteriorate the performance and shorten the use life of the projector. For solving these problems, a removable dust-proof cover is provided in the airflow inlet to shield the interior of the projector from the external dust. Although the use of the removable dust-proof cover can maintain performance and intend use life of the projector, there are still some drawbacks. For example, since dust-proof cover is usually formed of porous foam or nylon net, the dust-proof cover in front of the airflow inlet may reduce the airflow rate through the airflow inlet of the projector and thus the heat-dissipating efficiency is lowered. For adjusting the rotating speed of the cooling fan inside the projector when a dust-proof cover is provided, a detection device is usually provided in the junction between the dust-proof cover and the main body of the projector. For example, if the detection device detects that a dust-proof cover is present, the rotating speed of the cooling fan is increased to inhale much airflow into the interior of the projector. Therefore, the temperature inside the casing of the projector is effectively reduced, and the problems of causing low heat-dissipating efficiency, high lamp temperature and low use life when a dust-proof cover is present will be overcome. Whereas, if the detection device detects that no dust-proof cover is present, the rotating speed of the cooling fan can be lowered in order to achieve the power-saving purpose.

Please refer to FIG. 1A and FIG. 1B. FIG. 1A is a schematic circuit diagram of a detection device used in a projector according to the prior art. As shown in FIG. 1A, a detecting switch 10, for example a normally open switch may be electrically connected to a rear-side detecting circuit 16 through a connector 11 (e.g. a solder joint or an electric joint). In the connector 11, a first node 111 is connected to a constant voltage source V through a resistor R and a second node 112 is connected to a ground terminal. The potential at the node 111 is detected by the detecting circuit 16.

FIG. 1B is a truth table summarizing the operating modes of the projector to the connection statuses between the detecting switch and the connector of the detection device in FIG. 1A. Under the condition that the detecting switch 10 and the connector 11 are coupled with each other, if an object (e.g. a dust-proof cover) is placed into the detecting switch 10, the detecting switch 10 is closed and in an on state. Meanwhile, a low-level voltage signal indicating the presence of the object is detected by the detecting circuit 16. In response to the low-level voltage signal, the projector is operated in a cooling mode and thus the rotating speed of the cooling fan is increased to inhale much airflow and reduce the temperature inside the projector. Whereas, if no object is placed into the detecting switch 10, the detecting switch 10 is open and in an off state. Meanwhile, a high-level voltage signal indicating the absence of the object is detected by the detecting circuit 16. In response to the high-level voltage signal, the projector is operated in a normal mode and thus the cooling fan works in a normal rotating speed.

The use of the detection device shown in FIGS. 1A and 1B still has some drawbacks. For example, the connector 11 between the detecting switch 10 and the detecting circuit 16 is readily subject to damage or poor connecting or the connector 11 is not well welded or fixed during assembling. At this moment, regardless of whether the object is present or absent, the circuitry is still in the off state and thus a high-level voltage signal is detected by the detecting circuit 16. Therefore, the projector is continuously operated in the normal state. Under this circumstance, since the self-test function of the detection device is lost, the detection device fails to make a correct judgment and thus the temperature within the casing of the projector is possibly increased when the object in present.

Moreover, if the detecting switch 10 is not completely closed when the object is placed into the detecting switch 10, the circuitry is still in the off state and thus a high-level voltage signal is detected by the detecting circuit 16. Therefore, the projector is continuously operated in the normal state. Under this circumstance, the heat generated from the high temperature lamp of the projector fails to be effectively dissipated away and thus the temperature within the casing of the projector will be largely increased.

In other words, the temperature within the casing of the projector is often in danger of rapid increase if the connector 11 or the detecting switch 10 has a malfunction. Therefore, there is a need of providing an improved detection device so as to obviate the drawbacks encountered from the prior art.

### SUMMARY OF THE INVENTION

The present invention provides a detection device for detecting whether an object is mounted on a projector, thereby controlling internal operations of the projector.

In accordance with an aspect of the present invention, there is provided a detection device mounted in a projector for detecting relations between an object and the projector. The detection device includes a detecting switch, a connector and a detecting circuit. When an object is placed into the detecting switch, the detecting switch is in an off state. When the object is withdrawn from the detecting switch, the detecting switch is in an on state. The connector is electrically connected to the detecting switch. The detecting circuit is electrically connected to the connector for activating the projector to be operated in a first mode in response to the off state of the detecting switch and activating the projector to be operated in a second mode in response to the on state of the detecting switch. The first mode and the second mode are associated with the temperature inside the projector.

In an embodiment of the present invention, the object is a dust-proof cover. The first mode is a cooling mode and the second mode is a normal mode. The rotating speed of a cooling fan inside the projector in the cooling mode is higher than that in the normal mode. A message is shown on an on-screen display of the projector for indicating that the dust-proof cover is placed into the detecting switch and the projector enters the cooling mode.

In an embodiment of the present invention, the object is an air duct. The first mode is a power-saving mode and the second mode is a normal mode. The rotating speed of a cooling fan inside the projector in the power-saving mode is smaller than that in the normal mode. A message is shown on an on-screen display of the projector for indicating that the air duct is placed into the detecting switch and the projector enters the power-saving mode.

The detection device of the embodiments of the present invention obviates the drawbacks encountered from the prior art. If the dust-proof cover is placed into the detecting switch but the connector has a malfunction or breakdown, the detecting circuit activates the projector to be operated in the cooling mode to avoid rapid temperature increase. Moreover, if no dust-proof cover is placed into the detecting switch but the connector has a malfunction or breakdown, the detecting circuit also activates the projector to be operated in the cooling mode so as to notify the user that the detection device has erroneous function and the projector needs to be returned to the depot service. As a consequence, the problems of causing rapid temperature increase within the projector in the prior art when the connector or the detecting switch has a malfunction are overcome.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic circuit diagram of a detection device used in a projector according to the prior art;

FIG. 1B is a truth table summarizing the operating modes of the projector to the connection statuses between the detecting switch and the connector of the detection device in FIG. 1A;

FIG. 2 is a schematic circuit diagram of a detection device used in a projector according to a preferred embodiment of the present invention;

FIG. 3 is a truth table summarizing the operating modes of the projector to the connection statuses between the detecting switch and the connector of the detection device according to a first embodiment of the present invention;

FIG. 4 is a truth table summarizing the operating modes of the projector to the connection statuses between the detecting switch and the connector of the detection device according to a second embodiment of the present invention; and

FIG. 5 is a schematic circuit diagram illustrating an exemplary photo-sensing switch used in the detection device of an embodiment of the present invention.

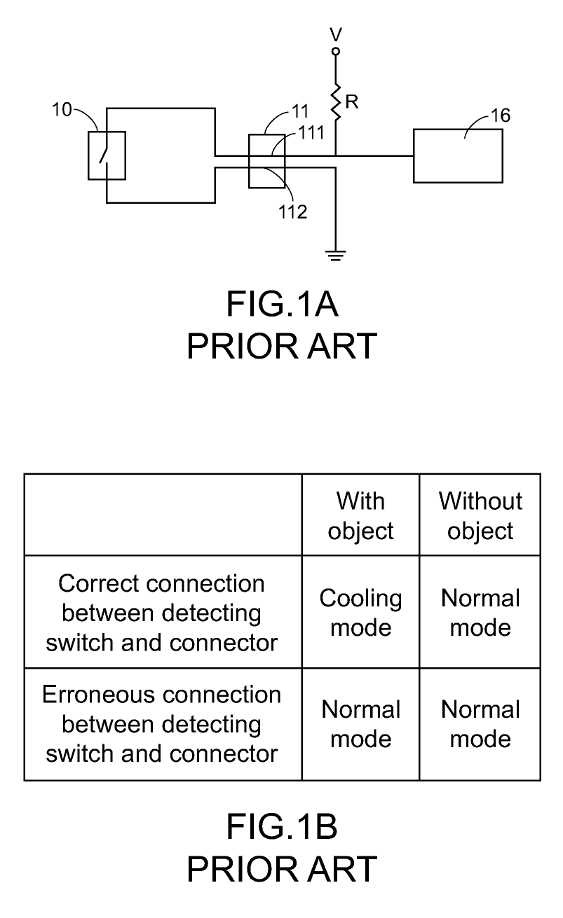

### DETAILED DESCRIPTION OF THE PREFERRED EMBODIMENT

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

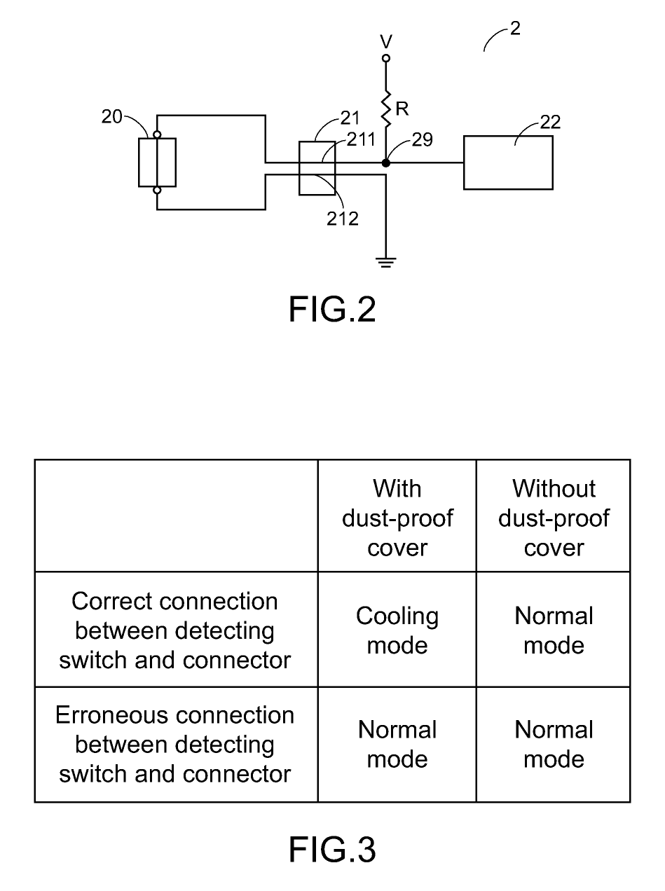

FIG. 2 is a schematic circuit diagram of a detection device used in a projector according to a preferred embodiment of the present invention. The detection device 2 of the present embodiment is mounted in a projector for detecting relation between the projector and an object. An exemplary object is a removable dust-proof cover. In the detection device 2 shown in FIG. 2, a detecting switch 20, for example a normally closed switch such as a normally closed mechanical switch, may be electrically connected to a rear-side detecting circuit 22 through a connector 21 (e.g. a solder joint or an electric joint). In the connector 21, a first node 211 is connected to a constant voltage source V through a resistor R and a second node 212 is connected to a ground terminal. The potential at a third node 29 between the first node 211 and the resistor R is detected by the detecting circuit 22.

The detecting switch 20 is electrically connected to the connector 21. In a case that the dust-proof cover is placed into the detecting switch 20, the detecting switch 20 is in an off state. In the off state of the detecting switch 20, the potential at the node 29 is uplifted to be substantially equal to the voltage of the constant voltage source V and thus a high-level voltage signal indicating the presence of the dust-proof cover is detected by the detecting circuit 22. In response to the high-level voltage signal, the projector is operated in a cooling mode. In the cooling mode, the rotating speed of the cooling fan inside the projector is increased to a level higher than that in the normal mode, so that much airflow is inhaled to increase the convection effect and reduce the temperature inside the projector. Under the condition that the detecting switch 20 and the connector 21 are coupled with each other, if no dust-proof cover is placed into the detecting switch 20, the detecting switch 20 is in an on state. In the on state of the detecting switch 20, the potential at the node 29 is lowered to be substantially equal to the ground voltage “zero” and thus a low-level voltage signal indicating the absence of the dust-proof cover is detected by the detecting circuit 22. In response to the low-level voltage signal, the projector is operated in a normal mode. Moreover, if the detecting switch 20 and the connector 21 are disconnected from each other, for example the connector 21 is damaged or the connector 21 is not well welded or fixed during assembling, the detecting switch 20 is electrically isolated from the connector 21. Regardless of whether the dust-proof cover is placed into the detecting switch 20, the potential at the node 29 is uplifted to be substantially equal to the voltage of the constant voltage source V and thus a high-level voltage signal is detected by the detecting circuit 22. In response to the high-level voltage signal, the projector is operated in a cooling mode.

Optionally, when the high-level voltage signal is detected by the detecting circuit 22, a message is shown on an on-screen display (OSD) of the projector for indicating that the presence of the dust-proof cover is placed into the detecting switch and the projector enters the cooling mode. That is, the message may notify the user of the current operating mode of the projector. On the other hand, if no dust-proof cover is placed into the detecting switch 20 but the above message is shown on the OSD, it is meant that erroneous connection between the detecting switch 20 and the connector 21 is rendered. Under this circumstance, the user may manually switch the operating mode of the projector from the cooling mode to the normal mode or even return the projector to the depot service. Hereinafter, the operating modes of the projector relating to the connection statuses between the detecting switch 20 and the connector 21 of the detection device 2 will be illustrated in more details with reference to FIG. 3.

FIG. 3 is a truth table summarizing the operating modes of the projector to the connection statuses between the detecting switch and the connector of the detection device according to a first embodiment of the present invention. According to the truth table of FIG. 3, there are four situations.

In the first situation, no dust-proof cover is placed into the detecting switch 20 but the connection between the detecting switch 20 and the connector 21 is correct. Since no dust-proof cover is placed into the detecting switch 20, the detecting switch 20 is in an on state. In the on state of the detecting switch 20, the potential at the node 29 is lowered to be substantially equal to the ground voltage “zero” and thus a low-level voltage signal indicating the absence of the dust-proof cover is detected by the detecting circuit 22. In response to the low-level voltage signal, the projector is operated in a normal mode.

In the second situation, no dust-proof cover is placed into the detecting switch 20 and erroneous connection between the detecting switch 20 and the connector 21 is rendered. Meanwhile, the potential at the node 29 is uplifted to be substantially equal to the voltage of the constant voltage source V and thus a high-level voltage signal is detected by the detecting circuit 22. In response to the high-level voltage signal, the projector is operated in a cooling mode. Moreover, the message indicating the cooling mode may be shown on the OSD of the projector. That is, even if no dust-proof cover is placed into the detecting switch 20 but the detecting switch 20 is electrically isolated from the connector 21 (for example the connector 21 is damaged or the connector 21 is not well welded or fixed during assembling), a high-level voltage signal is detected by the detecting circuit 22 and thus the projector is operated in the cooling mode to avoid rapid temperature increase. Moreover, since the message indicating the cooling mode is shown on the OSD but practically no dust-proof cover is placed into the detecting switch 20, the user may realize that the detection device 2 has a breakdown and the projector can be returned to the depot service to mend the erroneous connection.

In the third situation, a dust-proof cover is placed into the detecting switch 20 and the connection between the detecting switch 20 and the connector 21 is correct. When the dust-proof cover is placed into the detecting switch 20, the detecting switch 20 is in an off state. In the off state of the detecting switch 20, the potential at the node 29 is uplifted to be substantially equal to the voltage of the constant voltage source V and thus a high-level voltage signal indicating the presence of the dust-proof cover is detected by the detecting circuit 22. In response to the high-level voltage signal, the projector is operated in a cooling mode. Moreover, the message indicating the cooling mode may be shown on the OSD of the projector.

In the fourth situation, a dust-proof cover is placed into the detecting switch 20 but erroneous connection between the detecting switch 20 and the connector 21 is rendered. Meanwhile, the potential at the node 29 is uplifted to be substantially equal to the voltage of the constant voltage source V and thus a high-level voltage signal is detected by the detecting circuit 22. In response to the high-level voltage signal, the projector is operated in a cooling mode. Moreover, the message indicating the cooling mode may be shown on the OSD of the projector.

As described in the second and fourth situations, regardless of whether the dust-proof cover is placed into the detecting switch 20, the potential at the node 29 is uplifted to be substantially equal to the voltage of the constant voltage source V if erroneous connection between the detecting switch 20 and the connector 21 is rendered. As a consequence, a high-level voltage signal is detected by the detecting circuit 22 and the projector enters the cooling mode. From the above discussion, the detection device 2 of the present embodiment is capable of avoiding rapid temperature increase when the connector 21 has a malfunction and the dust-proof cover is placed into the detecting switch 20.

In the above embodiment, the present invention is illustrated by referring to a dust-proof cover as the object. Nevertheless, the detection device of the present embodiment may be used for detecting whether other peripheral component is mounted on the projector. An exemplary peripheral component includes a removable air duct. In a case that an air duct is mounted on the projector, more external airflow is inhaled into the interior of the projector to facilitate convection of the airflow inside the projector and thus the heat-dissipating efficiency is enhanced. In other words, since the arrangement of the air duct increases the inhaled airflow, the rotating speed of the cooling fan inside the projector may be decreased to a level smaller than that in the normal mode in order to achieve the power-saving purpose.

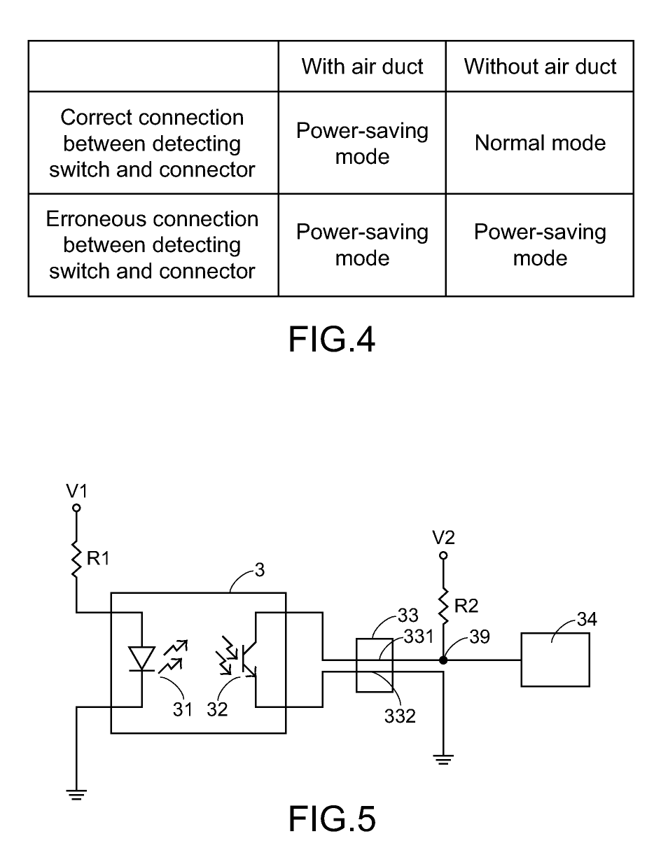

FIG. 4 is a truth table summarizing the operating modes of the projector to the connection statuses between the detecting switch and the connector of the detection device according to a second embodiment of the present invention. Likewise, there are four situations according to the truth table of FIG. 4.

In the first situation, no air duct is placed into the detecting switch 20 but the connection between the detecting switch 20 and the connector 21 is correct. Since no air duct is placed into the detecting switch 20, the detecting switch 20 is in an on state. In the on state of the detecting switch 20, the potential at the node 29 is lowered to be substantially equal to the ground voltage “zero” and thus a low-level voltage signal indicating the absence of the air duct is detected by the detecting circuit 22. In response to the low-level voltage signal, the projector is operated in a normal mode.

In the second situation, no air duct is placed into the detecting switch 20 and erroneous connection between the detecting switch 20 and the connector 21 is rendered. For example, if the connector 21 is damaged or the connector 21 is not well welded or fixed during assembling, the detecting switch 20 is electrically isolated from the connector 21. Meanwhile, the potential at the node 29 is uplifted to be substantially equal to the voltage of the constant voltage source V and thus a high-level voltage signal is detected by the detecting circuit 22. In response to the high-level voltage signal, the projector is operated in a power-saving mode. Moreover, the message indicating the power-saving mode may be shown on the OSD of the projector. Since the message indicating the power-saving mode is shown on the OSD but practically no air duct is placed into the detecting switch 20, the user may realize that the detection device 2 has a breakdown and the projector can be returned to the depot service to mend the erroneous connection.

In the third situation, an air duct is placed into the detecting switch 20 and the connection between the detecting switch 20 and the connector 21 is correct. When the air duct is placed into the detecting switch 20, the detecting switch 20 is in an off state. In the off state of the detecting switch 20, the potential at the node 29 is uplifted to be substantially equal to the voltage of the constant voltage source V and thus a high-level voltage signal indicating the presence of the air duct is detected by the detecting circuit 22. In response to the high-level voltage signal, the projector is operated in a power-saving mode. Moreover, the message indicating the power-saving mode may be shown on the OSD of the projector.

In the fourth situation, an air duct is placed into the detecting switch 20 but erroneous connection between the detecting switch 20 and the connector 21 is rendered. Meanwhile, the potential at the node 29 is uplifted to be substantially equal to the voltage of the constant voltage source V and thus a high-level voltage signal is detected by the detecting circuit 22. In response to the high-level voltage signal, the projector is operated in a power-saving mode. Moreover, the message indicating the power-saving mode may be shown on the OSD of the projector.

In the above embodiments, the detection device 2 may be used with a dust-proof cover or an air conduct. When the detection device 2 detects that the dust-proof cover is placed into the detecting switch 20, the projector enters the cooling mode. In the cooling mode, the rotating speed of the cooling fan inside the projector is increased to a level higher than that in the normal mode. Whereas, when the detection device 2 detects that the air duct is placed into the detecting switch 20, the projector enters the power-saving mode. In the power-saving mode, the rotating speed of the cooling fan inside the projector is decreased to a level smaller than that in the normal mode.

As previously described, the detecting switch used in the detection device of an embodiment of the present invention is a mechanical switch. Alternatively, the detecting switch may be a photo-sensing switch. The operation principles of the mechanical switch and the photo-sensing switch are substantially identical. When a duct-proof cover or an air duct is placed into the detecting switch, the mechanical switch or the photo-sensing switch detecting switch is in an off state. Whereas, when the duct-proof cover or the air duct is withdrawn from the detecting switch, the mechanical switch or the photo-sensing switch is in an on state.

FIG. 5 is a schematic circuit diagram illustrating an exemplary photo-sensing switch used in the detection device of an embodiment of the present invention. The photo-sensing switch 3 is implemented by an Opto-isolator or optical coupler (OC). In this embodiment, the photo-sensing switch 3 includes a light emitter 31 such as a light emitting diode (LED). A first terminal of the light emitter 31 is coupled to a ground terminal. A second terminal of the light emitter 31 is coupled to a resistor R1 and a constant voltage source V1. The photo-sensing switch 3 further includes a photo transistor as a photo sensor 32. The photo sensor 32 may be electrically connected to a rear-side detecting circuit 34 through a connector 33 (e.g. a solder joint or an electric joint). In the connector 33, a first node 331 is connected to another constant voltage source V2 through another resistor R and a second node 332 is connected to the ground terminal. The potential at a third node 39 between the first node 331 and the resistor R2 is detected by the detecting circuit 34.

The light emitter 31 is driven by the constant voltage source V1 to emit a light beam. When the light beam is received by the photo sensor 32, the photo sensor 32 generates a current. The current is further amplified and then outputted, so that the photo-sensing switch 3 is in an on state. In a case that a dust-proof cover is placed into the photo-sensing switch 3, the light beam emitted from the light emitter 31 is shielded by the dust-proof cover such that the photo-sensing switch 3 is in an off state. Meanwhile, the potential at the node 39 is uplifted to be substantially equal to the voltage of the constant voltage source V2 and thus a high-level voltage signal is detected by the detecting circuit 34. In response to the high-level voltage signal, the projector is operated in a cooling mode. On the other hand, when the dust-proof cover is withdrawn from the photo-sensing switch 3, the light beam emitted from the light emitter 31 may be normally received by the photo sensor 32 such that the photo-sensing switch 3 is in an on state. If the connection between the photo-sensing switch 3 and the connector 33 is correct, the potential at the node 29 is lowered to be substantially equal to the ground voltage “zero” and thus a low-level voltage signal is detected by the detecting circuit 34. In response to the low-level voltage signal, the projector is operated in a normal mode. Whereas, if erroneous connection between the photo-sensing switch 3 and the connector 33 is rendered, regardless of whether the dust-proof cover is placed into the photo-sensing switch 3, the potential at the node 39 is uplifted to be substantially equal to the voltage of the constant voltage source V2 and thus a high-level voltage signal is detected by the detecting circuit 34. In response to the high-level voltage signal, the projector is operated in a cooling mode. Moreover, the message indicating the cooling mode may be shown on the OSD of the projector to notify the user that the dust-proof cover is placed into the photo-sensing switch 3 and projector enters the cooling mode.

From the above description, it is found that the detection device of the embodiments of the present invention obviates the drawbacks encountered from the prior art. If the dust-proof cover is placed into the detecting switch but the connector has a malfunction or breakdown, the detecting circuit activates the projector to be operated in the cooling mode to avoid rapid temperature increase. Moreover, if no dust-proof cover is placed into the detecting switch but the connector has a malfunction or breakdown, the detecting circuit also activates the projector to be operated in the cooling mode so as to notify the user that the detection device has erroneous function and the projector needs to be returned to the depot service.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A detection device mounted in a projector, comprising:
a detecting switch being in an off state when an object is placed into the detecting switch and in an on state when the object is withdrawn from the detecting switch;
a connector electrically connected to the detecting switch; and
a detecting circuit electrically connected to the connector for activating the projector to be operated in a first mode in response to the off state of the detecting switch and activating the projector to be operated in a second mode in response to the on state of the detecting switch, wherein the first mode and the second mode are associated with the temperature inside the projector.

2. The detection device according to claim 1, wherein a high-level voltage signal is detected by the detecting circuit when the detecting switch is in the off state, and the projector enters the first mode in response to the high-level voltage signal; a low-level voltage signal is detected by the detecting circuit when the detecting switch is in the on state, and the projector enters the second mode in response to the low-level voltage signal.

3. The detection device according to claim 1, wherein the detecting switch comprises a photo-sensing switch, and the photo-sensing switch comprises:
a light emitter for emitting a light beam; and
a photo sensor electrically connected to the connector, wherein a current is generated by the photo sensor when the light beam emitted from the light emitter is received by the photo sensor such that the photo-sensing switch is in the on state, and the photo-sensing switch is in the off state when the light beam emitted from the light emitter is shielded by the object.

4. The detection device according to claim 3, wherein the photo-sensing switch comprises an Opto-isolator or optical coupler.

5. The detection device according to claim 1, wherein the detecting switch comprises a mechanical switch.

6. The detection device according to claim 1, wherein a high-level voltage signal is detected by the detecting circuit when the detecting switch is electrically isolated from the connector, and the projector enters the first mode in response to the high-level voltage signal.

7. The detection device according to claim 1, wherein the object comprises a dust-proof cover.

8. The detection device according to claim 7, wherein the first mode is a cooling mode and the second mode is a normal mode, a rotating speed of a cooling fan inside the projector in the cooling mode is higher than that in the normal mode, and a message is shown on an on-screen display of the projector for indicating that the dust-proof cover is placed into the detecting switch and the projector enters the cooling mode.

9. The detection device according to claim 1, wherein the object comprises an air duct.

10. The detection device according to claim 9, wherein the first mode is a power-saving mode and the second mode is a normal mode, a rotating speed of a cooling fan inside the projector in the power-saving mode is smaller than that in the normal mode, and a message is shown on an on-screen display of the projector for indicating that the air duct is placed into the detecting switch and the projector enters the power-saving mode.
